(19) United States
(12) Patent Application Publication
(10) Pub. No.: US 2005/0091848 A1
(43) Pub. Date: May 5, 2005

(54) Turbine blade and a method of manufacturing and repairing a turbine blade

(76) Inventors: Krassimir P. Nenov, Palm Harbor, FL (US); Arnold S. Samreth, Palm Harbor, FL (US); Mehrdad Vandyousseti, New Port Ritchey, FL (US)

Correspondence Address: MITCHELL D. BITTMAN, SEQUA CORPORATION, 3 UNIVERSITY PLAZA, HACKENSACK, NJ, 07601, US

(21) Appl. No.: 10/700,402

(22) Filed: Nov. 3, 2003

(51) Int. Cl. B23P 6/00; B23P 19/04; B63H 1/26

(52) U.S. Cl. 29/889.1; 29/402.08; 416/223 R

(57) ABSTRACT

A turbine blade and a process for manufacture of turbine blades is provided comprising: casting as one piece a blade body and a first portion of an airfoil; forming a tip section having a tip cap and a second portion of an airfoil which is sized to fit on the first portion of the airfoil; and attaching the first portion of the airfoil to the second portion of the airfoil. A process for repairing turbine blades is provided which comprises: removing the tip cap and a portion of the airfoil from the blade to form a repair surface on the airfoil; forming a replacement tip section comprising a replacement tip cap and a replacement portion of the airfoil sized to fit onto the repair surface; and attaching the replacement tip section to the repair surface.

### BACKGROUND OF THE INVENTION

This invention relates to turbine blades for gas turbine engines and the manufacture of a turbine blade having a blade body and a separately formed tip section and more particularly wherein the blade body comprises a first portion of the airfoil and the tip section comprises a tip cap and a second portion of the airfoil. This invention further provides for the repair of a turbine blade by removal of the tip cap and a portion of the airfoil and forming and attaching a replacement tip section comprising a replacement tip cap and a replacement portion of the airfoil.

Turbine blades have different operation requirements which apply to different areas of the blade. The blade tip cap has to resist rubbing, has to be more oxidation resistant then the blade airfoil and does not carry large centrifugal or bending loads (no benefit for directionally solidified or single crystal structure). The blade airfoil does not need to resist rubbing, carries large centrifugal and bending loads (benefit for use of directionally solidified or single crystal structures) and has to resist foreign object damage (FOD).

There are difficulties in the manufacture of turbine blades. When casting hollow blades, the lack of an exit from the blade tip for the ceramic core used in casting the turbine blade reduces the ability to maintain the thickness of the blade airfoil as it is difficult to hold the ceramic core in its proper position. After casting as access to the ceramic core is limited it is difficult and time consuming to remove the ceramic core and to inspect the blade to insure the ceramic core has been removed. One process of ceramic core removal is potassium hydroxide leaching which due to the limited access can take up to 48 hours. Further, the casting of single crystal or directionally solidified turbine blades with a tip cap is more difficult as the tip cap and the tip geometry interferes with the crystal structure formation.

With regard to the repair of high-pressure turbine blades, the blade tip section is the most common area of damage. Typically the blade tip undergoes cracking and wear through rubbing. Current repair methods do not completely restore the strength of the tip, with welding and other tip repairs generally compromising the strength of the airfoil in the vicinity of the blade tip leading to premature non-repairable conditions and scraping of the blade after further service.

FIGS. 1a and 1b illustrate turbine blades 10 as are known in the prior art for use in gas turbine engines, such as in the first row of blades of a gas or combustion turbine. Turbine blade 10 includes a blade root 11, a platform 17, an airfoil portion 12, and a tip portion 13. The blade root 11 is designed to be inserted into and retained by a disc on a rotating shaft (not shown) of the turbine. The airfoil 12 is shaped to extract energy from combustion gases passing over the airfoil 12, thereby imparting rotating mechanical energy to the turbine shaft. For modern gas turbine engines, airfoil 12 is designed to include one or more cooling passages formed below the surface of the airfoil for the passage of cooling air necessary to insure the integrity of the blade material in the hot combustion gas environment. Such cooling passages may be formed in a forged blade by a drilling process or may be formed directly in a cast material blade. For cast turbine blades, the cooling passages are formed by supporting a ceramic core within the volume of the mold as the material of the blade is cast. In spite of efforts to maintain the core in its proper position during the casting process, many cast blades are rejected due to a minimum wall violation caused by unintended movement of the core resulting in a cooling passage being located proximate a airfoil surface.

The turbine blade 10 is designed to rotate within a casing (not shown). It is important for the blade tip 13 to fit precisely within the casing in order to minimize the passage of combustion gases around the blade tip 13, since such bypass gases impart no energy to the airfoil 12. In one embodiment as shown in FIG. 1a a tip cap 14 is provided with a squealer tip 15 which is a raised lip extending around the periphery of the blade tip 13. In a second embodiment as shown in FIG. 1b a tip cap 14 is solid and does not have a squealer tip. Typically the blade tip 13 whether solid or hollow will have an oxidation resistant and abrasive material applied to the surface in order to resist rubbing and to form an initial path into the turbine seal.

### SUMMARY OF THE INVENTION

A turbine blade is provided which comprises: a blade body and a first portion of an airfoil cast as a single piece, a distinct tip section comprising a tip cap and a second portion of an airfoil sized to fit on the first portion of the airfoil; and the first portion of the airfoil being attached to the second portion of the airfoil.

A process is provided for manufacture of turbine blades which comprises; casting as one piece a blade body and a first portion of an airfoil; forming a tip section having a tip cap and a second portion of an airfoil which is sized to fit on the first portion of the airfoil; and attaching the first portion of the airfoil to the second portion of the airfoil.

A process for repairing turbine blades is provided which comprises: removing the tip cap and a portion of the airfoil from the blade to form a repair surface on the airfoil; forming a replacement tip section comprising a replacement tip cap and a replacement portion of the airfoil sized to fit onto the repair surface; and attaching the replacement tip section to the repair surface.

### BRIEF DESCRIPTION OF THE DRAWINGS

FIG. 1a is a perspective view of a prior art turbine blade with a squealer tip cap.

FIG. 1b is a perspective view of a prior art turbine blade with a solid tip cap.

FIG. 2a is a perspective view of a blade body with a first portion of an airfoil.

FIG. 2b is a cross sectional view of FIG. 2a.

FIG. 3a is a perspective view of a tip section with a tip cap having a squealer tip and with a second portion of an airfoil.

FIG. 3b is a cross sectional view of FIG. 3a.

FIG. 4a is a perspective view of a tip section with a solid tip cap and with a second portion of an airfoil.

FIG. 4b is a cross sectional view of FIG. 4a.

FIG. 5a is a perspective view of a turbine blade wherein a tip section with a tip cap having a squealer tip and a second portion of an airfoil is attached to a blade body and first portion of an airfoil.

FIG. 5b is a cross sectional view of FIG. 5a.

FIG. 6a is a perspective view of a turbine blade wherein a tip section with a tip cap and a second portion of an airfoil is attached to a blade body and a first portion of an airfoil.

FIG. 6b is a cross sectional view of FIG. 6a.

FIG. 7a is a side view of a damaged turbine blade.

FIG. 7b is a side view of the turbine blade of FIG. 7a with the damaged portion, which includes the tip cap and a portion of the airfoil, is removed.

FIG. 7c is a side view of repaired turbine blade with the replacement tip section attached to the repair surface.

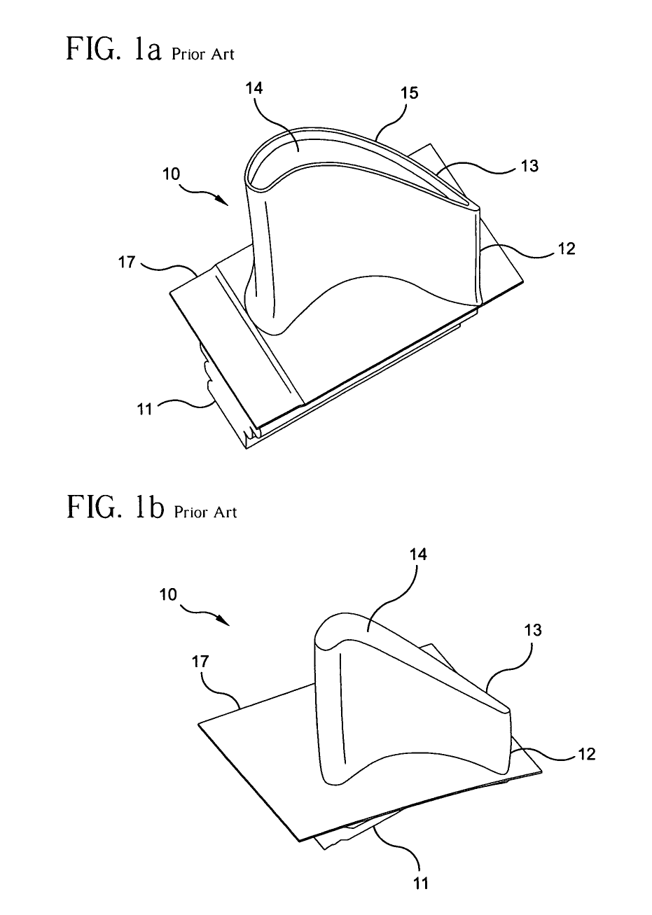

### DETAILED DESCRIPTION OF THE INVENTION

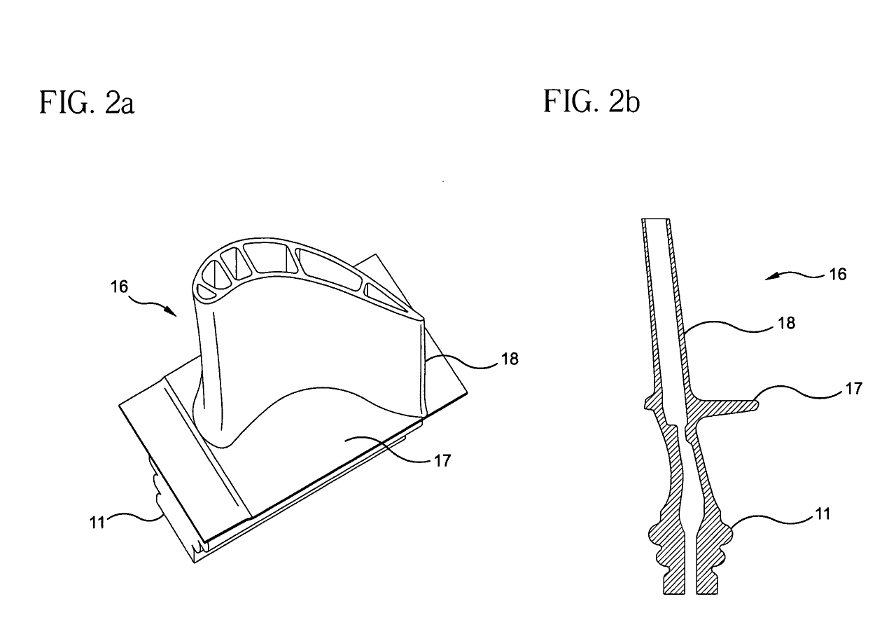

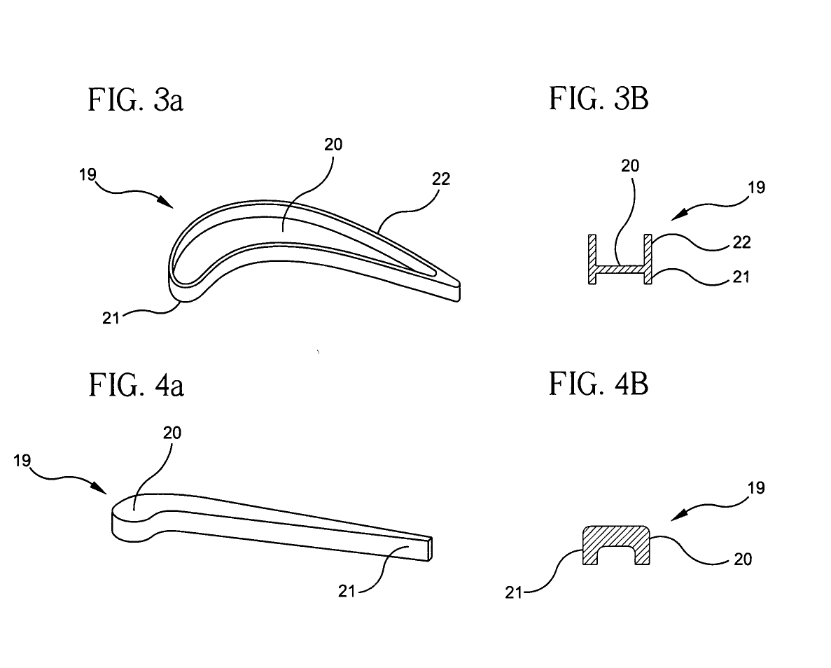

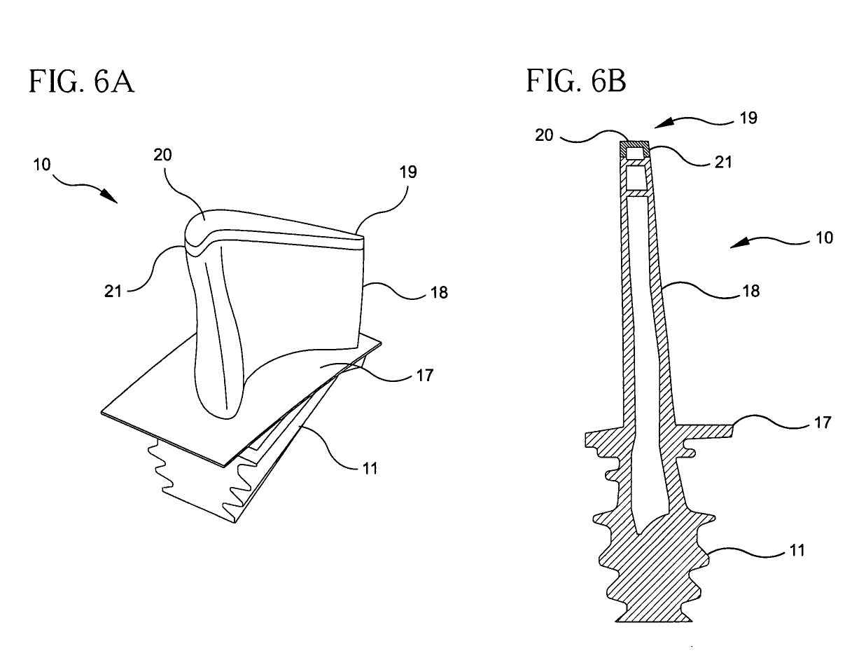

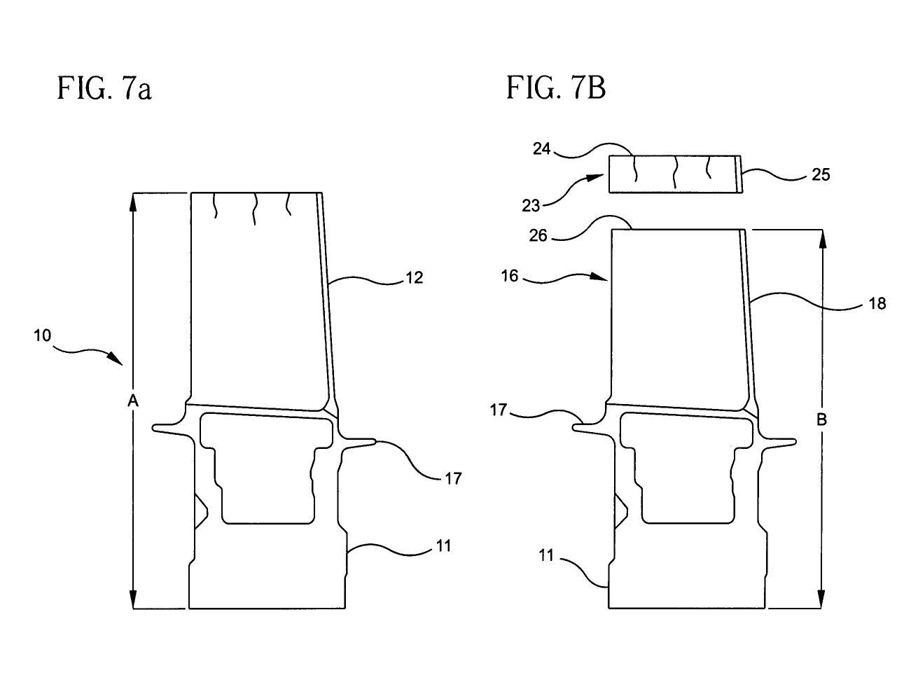

In accordance with this invention a turbine blade, a method of manufacture of a turbine blade and a method of repair of a turbine blade is provided. In FIGS. 2-7 a newly manufactured or repaired turbine blade 10 is shown which is made of at least two pieces and generally comprises a blade body 16 and a tip section 19. The blade body has a blade root 11, a blade platform 17 and a first airfoil portion 18. The tip section 19 has a tip cap 20 and a second airfoil portion 21. In one embodiment as shown in FIGS. 3a, 3b, 5a and 5b the tip cap 20 also has a squealer tip 22. The newly manufactured or repaired blade is an assembly of the blade body 16 and tip section 19 using a suitable bonding method such as thermal or thermo-mechanical diffusion bonding, brazing, welding, etc.

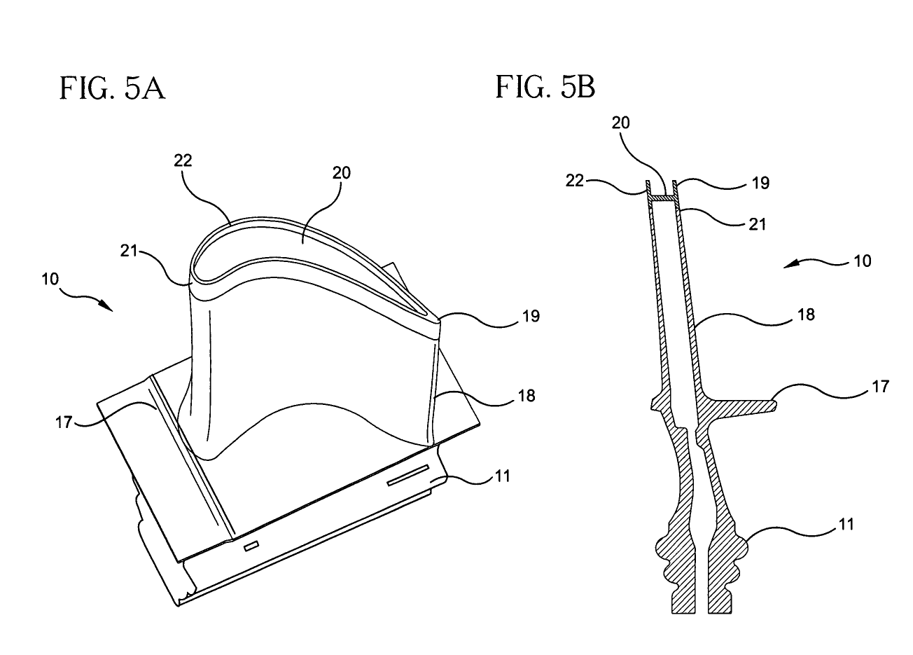

When a new blade is made in accordance with the invention, the blade body 16 is manufactured without any tip cap (see FIGS. 2a and 2b). The blade body 16 is produced slightly longer than needed. No special attachment platforms, protrusions, or devices are required to be added to the blade body 16 to facilitate the attachment of the tip section 19. A tip section 19 is manufactured separately (see FIGS. 3a, 3b, 4a and 4b). Similarly, the tip section 19 is produced slightly longer than needed. Using additional processes, the tip section maybe coated with an abrasive in order to improve its resistance to rubbing. The blade body 16 and/or tip section 19 are subsequently machined to size and bonded together in order to produce a blade of the desired overall height (see FIGS. 5a, 5b, 6a, 6b and 7c). Subsequently, the assembled blade may be coated and heat-treated in order to increase its environmental resistance properties and mechanical strength.

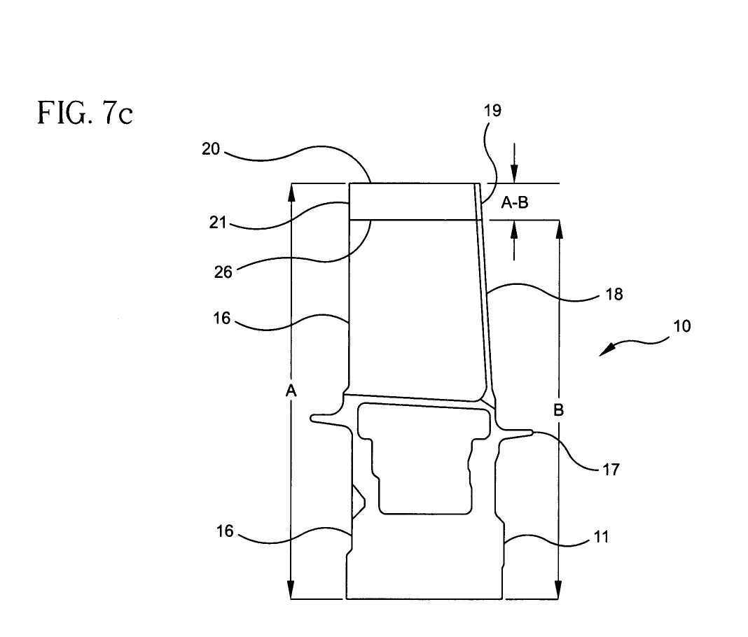

A turbine blade manufactured as described above, or in accordance with the prior art can be repaired in accordance with this invention as illustrated in FIGS. 7a, 7b and 7c. A blade 10 is machined using a suitable method to remove the tip cap 24 and a portion of the airfoil 25 to open the internal cavity and produce an open blade body 16 having a repair surface 26 on the airfoil 18. The length of the removed section 23 depends on the extent of the area that needs repair. A replacement tip section 19 comprising a replacement tip cap 20 and a replacement portion of an airfoil 21 is manufactured so that it can be machined to any length needed for the repair. The replacement tip section 19 is then machined to the required length (A-B) based on the length of the previously prepared blade body 16(B) and fitted on the repair surface 26. Subsequently, replacement tip section 19 and blade body 16 are bonded together in order to produce a blade of the desired overall height (A). Finally, the assembled blade may be coated and heat-treated in order to increase its environmental resistance properties and mechanical strength. The repairable length (as measured from the tip toward the base of the airfoil) is limited by the creep strength, oxidation resistance and other properties of the specific bonding method used to unite the blade body 16 to the replacement tip section 19.

The blade body 16 and tip section 19 may be of any geometry desired, such as a hollow blade body with internal cooling passages or a solid blade body. The tip section can have a tip cap 20 with a squealer tip 22 or it can be a full solid tip cap and the tip section 19 may be made of one, two, or more materials. The base material of the tip section may or may not be identical to that of the blade body 16. For instance, the tip section 19 or only the tip cap 20 may be made of a harder material than that of the blade body 16 and an abrasive material may be applied in order to improve rub resistance. The required cooling holes in the blade body 16 and tip section 19 may be drilled during manufacture or after the complete blade 10 has been assembled.

Generally, the length of the second airfoil portion 21 of the tip section 19 or the replacement airfoil portion 21 (when repairing a turbine blade) is limited so that the interface area where it is attached to the first portion of the airfoil or the repair surface is not in a high stress region of the airfoil. Typically, the second portion of the airfoil will be from greater than 0% to about 25% of the total airfoil length. Typically the length of the second portion of the airfoil 21 or replacement airfoil portion 21 is from greater than 0 cm to about 2 cm, preferably about 0.2 cm to about 1.2 cm.

The process of manufacturing new blades in accordance with this invention provides enhanced blade casting manufacturability and improved casting yield for hollow blades resulting from having an exit at the tip of the airfoil to locate and remove the ceramic core. Quartz rods are not necessary for casting and it is easier to maintain airfoil wall thickness. As the tip section is not present to interfere with crystal formation it is easier to obtain directionally solidified and single crystal orientation. Casting yields are also higher and castings are less expensive. In addition, for hollow blades, core removal after casting is greatly simplified as a shorter and less expensive process is required. Also, because of the easy access to the internal airfoil cavity there is no need for neutron radiography inspection for residual core material resulting in shorter turn times and reduced manufacturing cost. The inspectability of the casting is also enhanced as all blade cavities are accessible through the tip allowing comprehensive internal inspections for non-fill, residual core material, braze-ball defects, thin ribs, and other casting defects, as well as internal fluorescent penetrant (FPI) inspection. It is also possible for hollow blades to provide a more complex internal blade geometry due to enhanced casting manufacturability as a result of the core exit at the tip of the airfoil. The greater design freedom can provide optimized airfoil strength and cooling schemes, and longer overall blade life.

Generally the blade body 16 can be formed from a first superalloy material such as an equiax, directionally solidified or single-crystal nickel-based superalloy. The tip materials can also be optimized for tip-specific requirements, high oxidation resistance, rub resistance, etc. Greater freedom in choice of materials is possible where the tip section or tip cap does not have to be made from the same alloy as the airfoil. The tip section can be formed from the same or distinct materials. The tip section can be formed from a second superalloy material such as an equiax, directionally solidified or single-crystal superalloy, or from an altogether different material such as ceramic.

The tip section material could be upgraded during the repair of a turbine blade manufactured in accordance with the prior art, for instance, an equiax blade may receive a single-crystal tip section for improved durability. The tip section geometry can also be optimized for tip-specific requirements as separate tip manufacturing allows greater freedom in tip geometry. Separate tip section manufacturing is also easier and less expensive, e.g. abrasive tips are easier and less expensive to produce. The tip section can be cast as one piece or the tip cap and second airfoil portion can be cast or manufactured separately and then assembled. A variety of manufacturing methods can be used to produce the tip section, depending on the material of choice, e.g. powder metallurgy, die injection, sintering, casting, laser welding, powder deposition, electrical discharge machining, or others.

The turbine blade tip section/blade body assembly, if designed properly, may allow tip cracks in service to be arrested in the interface and not propagate further into the airfoil resulting in increased service life. Reparability is enhanced and the repair costs are lowered in that removal of the old tip section and replacing with a new one is possible with the tip sections being consumable details resulting in reduced repair turn time, cost, and better repair quality.

For hollow blades, removal of the tip section during repair allows easy access to the internal airfoil cavities for cleaning, inspection (e.g. internal coating inspection), FPI, hole redrilling, etc. For all blades, because welding of the tip section walls is no longer necessary, blade life otherwise adversely affected by weld repair will increase.

1. A method of repairing a gas turbine engine turbine blade, the blade having an airfoil and a tip cap on the airfoil at the tip of the blade comprising: removing the tip cap and a portion of the airfoil from the blade to form a repair surface on the airfoil; forming a replacement tip section comprising a replacement tip cap and a replacement portion of an airfoil sized to fit onto the repair surface; and attaching the replacement tip section to the repair surface.

2. Method of claim 1 wherein the blade having the airfoil and the tip cap have been cast as one piece.

3. Method of claim 1 wherein the tip cap has a squealer tip extending beyond the tip cap.

4. Method claim 3 wherein the blade, the tip cap and the squealer portion have been manufactured as one piece.

5. Method of claim 3 wherein the replacement tip section further comprises a replacement squealer tip.

6. Method of claim 1 further comprising drilling cooling holes into the replacement tip section.

7. Method of claim 1 the replacement tip section is attached to the repair surface by welding, brazing, or thermal or thermo-mechanical diffusion bonding.

8. Method of claim 1 where the replacement tip section is cast as one piece.

9. Method of claim 1 wherein the length of the replacement portion of the airfoil is from greater than 0 cm to about 2 cm.

10. Method of claim 8 wherein the repair surface and the replacement tip section are machined to size to provide a repaired blade with a desired height.

11. A gas turbine engine turbine blade which comprises:
a blade body having a first portion of an airfoil cast as one piece;
a distinct tip section comprising a tip cap and a second portion of an airfoil which is sized to fit on the first portion of the airfoil; and
the first portion of the airfoil of the blade body being attached to the second portion of the airfoil of the tip section.

12. Blade of claim 11 wherein the first portion is attached to the second portion by welding, brazing, or thermal or thermo-mechanical diffusion bonding.

13. Blade of claim 11 wherein the length of the second portion of the airfoil is from greater than 0% to about 25% of the total length of both the first portion and the second portion of the airfoil.

14. Blade of claim 11 wherein the blade body and the tip section are formed from the same superalloy material.

15. Blade of claim 11 wherein the blade body is formed from a first superalloy material and at least a portion of the tip section are formed from a second material distinct from the first superalloy material.

16. Blade of claim 15 wherein the first superalloy material is selected from the group consisting of equiax, directionally solidified and single-crystal nickel-base superalloys.

17. Blade of claim 15 wherein the second superalloy material is selected from the group consisting of equiax, directionally-solidified and single-crystal nickel-base superalloys and a ceramic material.

18. Blade of claim 11 wherein the length of the second portion of the airfoil is from greater than 0 cm to about 2 cm.

19. Blade of claim 11 wherein the tip cap further comprises a squealer tip.

20. Blade of claim 11 wherein the tip section is cast as one piece.

21. A process for manufacturing a turbine blade comprising:
casting as one piece a blade body having a first portion of an airfoil;
forming a tip section having a tip cap and a second portion of an airfoil which is sized to fit on the first portion of the airfoil; and
attaching the first portion of the airfoil to the second portion of the airfoil.

22. Blade of claim 21 wherein the first portion is attached to the second portion by welding, brazing, or thermal or thermo-mechanical diffusion bonding.

23. Blade of claim 11, wherein the length of the second portion of the airfoil is from greater than 0% to about 25% of the total length of both the first portion and the second portion of the airfoil.

24. Blade of claim 21 wherein the blade body and the tip section are formed from the same superalloy material.

25. Blade of claim 21 wherein the blade body is formed from a first superalloy material and at least a portion of the tip section are formed from a second material distinct from the first superalloy material.

26. Blade of claim 25 wherein the first superalloy material is selected from the group consisting of equiax, directionally-solidified and single-crystal nickel-base superalloys.

27. Blade of claim 25 wherein the second material is selected from the group consisting of equiax, directionally-solidified and single-crystal nickel-base superalloys and a ceramic material.

28. Blade of claim 21 wherein the length of the second portion of the airfoil is from 0 cm to about 2 cm.

29. Blade of claim 21 wherein the tip cap further comprises a squealer tip.

30. Blade of claim 21 wherein the tip section is cast as one piece.
